(19) United States
(12) Patent Application Publication
(10) Pub. No.: US 2024/0040966 A1
(43) Pub. Date: Feb. 8, 2024

(54) SYSTEMS AND METHODS FOR VISUALIZING THE ORIENTATION OF HARVESTING IMPLEMENTS

(71) Applicant: CNH Industrial America LLC, New Holland, PA (US)

(72) Inventors: Joel T. Cook, Akron, PA (US); Cory Douglas Hunt, Millersville, PA (US); Preston L. McKinney, Rebersburg, PA (US); Jethro Martin, Ephrata, PA (US)

(21) Appl. No.: 17/882,972

(22) Filed: Aug. 8, 2022

(51) Int. Cl. A01D 41/14

(52) U.S. Cl. CPC A01D 41/141; A01D 41/144

(57) ABSTRACT

In one aspect, a system for visualizing the orientation of a harvesting implement configured for use with an agricultural harvester. The system includes a display device and a computing system communicatively coupled to the display device. The computing system is configured to receive data associated with an orientation of at least one section of the harvesting implement, and cause an implement orientation interface to be presented on the display device. The implement orientation interface includes an implement interface element representing the at least one section of the harvesting implement and at least one curved display indicator positioned relative to the implement interface element, with the at least one curved display indicator providing an indication of the orientation of the at least one section of the harvesting implement.

### FIELD OF THE INVENTION

The present subject matter relates generally to harvesting implements for agricultural vehicles, and, more particularly, to systems and methods for visualizing the orientation of a harvesting implement, such as an articulating header.

### BACKGROUND OF THE INVENTION

A harvester is an agricultural machine that is used to harvest and process crops. For instance, a forage harvester may be used to cut and comminute silage crops, such as grass and corn. Similarly, a combine harvester may be used to harvest grain crops, such as wheat, oats, rye, barely, corn, soybeans, and flax or linseed. In general, the objective is to complete several processes, which traditionally were distinct, in one pass of the machine over a particular part of the field. In this regard, most harvesters are equipped with a detachable harvesting implement, such as a header, which cuts and collects the crop from the field and feeds it to the base harvester for further processing.

In certain instances, headers are equipped with multi-section articulating headers. In such instances, in addition to being able to adjust the tilt angle of the header, the individual wing sections can be articulated or pivoted relative to the central header section to adjust the wing pivot angles. As the tilt/pivot angles of the header is/are being adjusted, it is important to inform the operator of the current orientation of the various sections of the header. However, to date, currently available user interfaces utilize less than optimal methodologies and display elements to provide the operator with such information.

Accordingly, improved systems and methods for visualizing the orientation of a harvesting implement would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a system for visualizing the orientation of a harvesting implement configured for use with an agricultural harvester. The system includes a display device and a computing system communicatively coupled to the display device. The computing system is configured to receive data associated with an orientation of at least one section of the harvesting implement, and cause an implement orientation interface to be presented on the display device. The implement orientation interface includes an implement interface element representing the at least one section of the harvesting implement and at least one curved display indicator positioned relative to the implement interface element, with the at least one curved display indicator providing an indication of the orientation of the at least one section of the harvesting implement.

In another aspect, the present subject matter is directed to a method for visualizing the orientation of a harvesting implement configured for use with an agricultural harvester. The method includes receiving, with a computing system, data associated with an orientation of at least one section of the harvesting implement and causing, with the computing system, an implement orientation interface to be presented on the display device. The implement orientation interface includes an implement interface element representing the at least one section of the harvesting implement and at least one curved display indicator positioned relative to the implement interface element, with the at least one curved display indicator providing an indication of the orientation of the at least one section of the harvesting implement

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a simplified, partial sectional side view of one embodiment of an agricultural harvester in accordance with aspects of the present subject matter;

FIG. 2 illustrates a simplified, schematic view of one embodiment of a multi-section, articulating harvesting implement configured for use with an agricultural harvester in accordance with aspects of the present subject matter;

FIG. 3 illustrates another schematic view of the harvesting implement shown in FIG. 2, particularly illustrating a central section of the harvesting implement being titled in accordance with aspects of the present subject matter;

FIG. 4 illustrates another schematic view of the harvesting implement shown in FIG. 2, particularly illustrating wing sections of the harvesting implement being pivoted relative to the central section of the harvesting implement in accordance with aspects of the present subject matter;

FIG. 5 illustrates one embodiment of a system for visualizing the orientation of a harvesting implement in accordance with aspects of the present subject matter;

FIG. 6 illustrates an exemplary view of one embodiment of a graphical user interface in accordance with aspects of the present subject matter, particularly illustrating one embodiment of an implement orientation interface of the graphical user interface for presenting the current orientation of a harvesting implement;

FIG. 7 illustrates an enlarged view of the embodiment of the implement orientation interface of the graphical user interface shown in FIG. 6;

FIG. 8 illustrates an exemplary view of another embodiment of an implement orientation interface suitable for use within a graphical user interface in accordance with aspects of the present subject matter; and

FIG. 9 illustrates a flow diagram of one embodiment of a method for visualizing the orientation of a harvesting implement in accordance with aspects of the present subject matter.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to systems and methods for visualizing the orientation of a harvesting implement configured for use with an agricultural harvester. Specifically, in several embodiments, the disclosed system and method may be adapted to present a graphical user interface to an operator/user that includes an implement orientation interface providing a visual representation of the current orientation of the harvesting implement. As will be described below, the implement orientation interface incorporates one or more curved display indicators to indicate the degree of actuation of movement of one or more respective sections of the harvesting implement, thereby providing a more intuitive means for displaying such information to the operator/user.

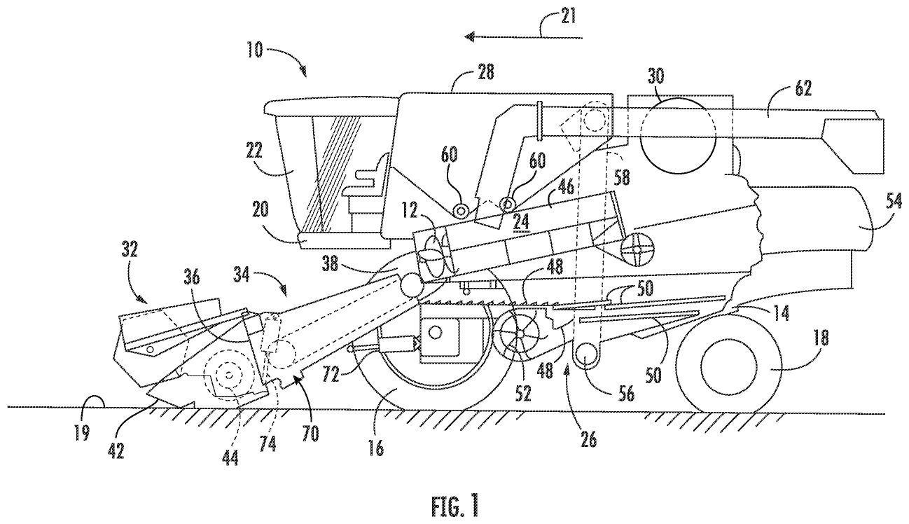

Referring now to the drawings, FIG. 1 illustrates a simplified, partial sectional side view of one embodiment of a work vehicle, such as an agricultural harvester 10. The harvester 10 may be configured as an axial-flow type combine, wherein crop material is threshed and separated while it is advanced by and along a longitudinally arranged rotor 12. The harvester 10 may include a chassis or main frame 14 having a pair of driven, ground-engaging front wheels 16 and a pair of steerable rear wheels 18. The wheels 16, 18 may be configured to support the harvester 10 relative to a ground surface 19 and move the harvester 10 in a forward direction of movement (indicated by arrow 21 in FIG. 1) relative to the ground surface 19. Additionally, an operator's platform 20 with an operator's cab 22, a threshing and separating assembly 24, a grain cleaning assembly 26 and a holding tank 28 may be supported by the frame 14. Additionally, as is generally understood, the harvester 10 may include an engine and a transmission mounted on the frame 14. The transmission may be operably coupled to the engine and may provide variably adjusted gear ratios for transferring engine power to the wheels 16, 18 via a drive axle assembly (or via axles if multiple drive axles are employed).

Moreover, as shown in FIG. 1, a harvesting implement (e.g., a header 32) and an associated feeder 34 may extend forward of the main frame 14 and may be pivotally secured thereto for generally vertical movement. In general, the feeder 34 may be configured to serve as support structure for the header 32. As shown in FIG. 1, the feeder 34 may extend between a front end 36 coupled to the header 32 and a rear end 38 positioned adjacent to the threshing and separating assembly 24. As is generally understood, the rear end 38 of the feeder 34 may be pivotally coupled to a portion of the harvester 10 to allow the front end 36 of the feeder 34 and, thus, the header 32 to be moved upwardly and downwardly relative to the ground 19 to set the desired harvesting or cutting height for the header 32.

As the harvester 10 is propelled forwardly over a field with standing crop, the crop material is severed from the stubble by a sickle bar 42 at the front of the header 32 and delivered by a header auger 44 to the front end 36 of the feeder 34, which supplies the cut crop to the threshing and separating assembly 24. As is generally understood, the threshing and separating assembly 24 may include a cylindrical chamber 46 in which the rotor 12 is rotated to thresh and separate the crop received therein. That is, the crop is rubbed and beaten between the rotor 12 and the inner surfaces of the chamber 46, whereby the grain, seed, or the like, is loosened and separated from the straw.

Crop material which has been separated by the threshing and separating assembly 24 falls onto a series of pans 48 and associated sieves 50, with the separated crop material being spread out via oscillation of the pans 48 and/or sieves 50 and eventually falling through apertures defined in the sieves 50. Additionally, a cleaning fan 52 may be positioned adjacent to one or more of the sieves 50 to provide an air flow through the sieves 50 that removes chaff and other impurities from the crop material. For instance, the fan 52 may blow the impurities off of the crop material for discharge from the harvester 10 through the outlet of a straw hood 54 positioned at the back end of the harvester 10.

The cleaned crop material passing through the sieves 50 may then fall into a trough of an auger 56, which may be configured to transfer the crop material to an elevator 58 for delivery to the associated holding tank 28. Additionally, a pair of tank augers 60 at the bottom of the holding tank 28 may be used to urge the cleaned crop material sideways to an unloading tube 62 for discharge from the harvester 10.

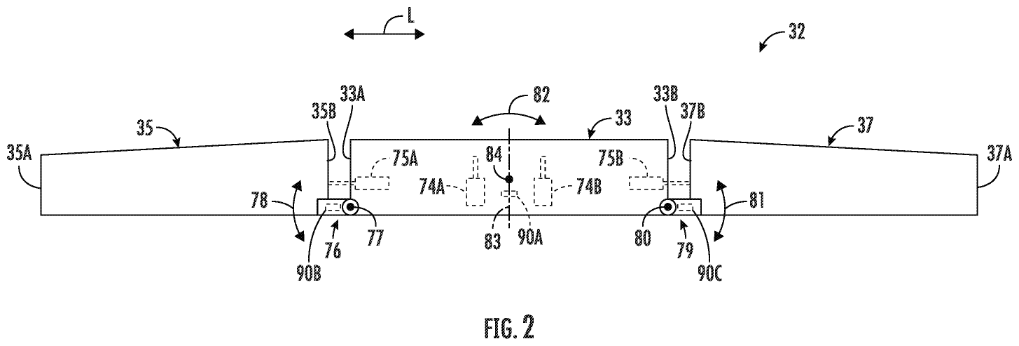

Moreover, in several embodiments, the harvester 10 may also include a header adjustment system 70 which is configured to adjust a height of the header 32 relative to the ground surface 19 so as to maintain the desired cutting height between the header 32 and the ground surface 19. The header adjustment system 70 may include a height actuator 72 (e.g., a hydraulic cylinder) configured to adjust the height or vertical positioning of the header 32 relative to the ground. For example, in some embodiments, the height cylinder 72 may be coupled between the feeder 34 and the frame 14 such that the height cylinder 72 may pivot the feeder 34 to raise and lower the header 32 relative to the ground 19. In addition, the header adjustment system 70 may also include one or more actuators configured to adjust the orientation of the header 32 relative to the ground 19. For instance, as shown in FIG. 1, the header adjustment system 70 may include a tilt cylinder(s) 74 coupled between the header 32 and the feeder 34 to allow the header 32 to be tilted relative to the ground surface 19 or pivoted laterally or side-to-side relative to the feeder 34. Additionally, as will be described below with reference to FIG. 2, the header adjustment system 70 may also include wing actuators 75 (FIG. 2) configured to allow the orientation of wing sections of the header 32 to be adjusted relative to a central or main section of the header 32.

Referring now to FIG. 2, a simplified, schematic view of one embodiment of a header (e.g., header 32) suitable for use with the harvester 10 described above with reference to FIG. 1 is illustrated in accordance with aspects of the present subject matter. Specifically, in the illustrated embodiment, the header 32 is configured as a multi-section articulating header including a central section 33 and first and second wing sections 35, 37 pivotably coupled to the central section 33. For instance, as shown in FIG. 1, the central section 33 extends side-to-side or in a lateral direction (indicated by arrow L in FIG. 2) between a first lateral end 33A and a second lateral end 33B. Additionally, the first wing section 35 extends in the lateral direction between a first outboard end 35A of the header 32 and a first joint end 35B, with the first joint end 35B being pivotably coupled to the first lateral end 33A of the central section 33 via a hinge or articulation joint 76 to allow the first wing section 35 to be pivoted relative to the central section 33 about a first pivot axis 77 in a first pivot direction (indicated by arrow 78 in FIG. 2). Similarly, the second wing section 35 extends in the lateral direction between a second outboard end 37A of the header 32 and a second joint end 37B, with the second joint end 37B being pivotably coupled to the second lateral end 33B of the central section 33 via a hinge or articulation joint 79 to allow the second wing section 37 to be pivoted relative to the central section 33 about a second pivot axis 80 in a first pivot direction (indicated by arrow 81 in FIG. 2).

In several embodiments, the central section 33 of the header 32 may be pivotably coupled to the feeder 34 (FIG. 1) at a location between its first and second lateral ends 33A, 33B to allow the header 32 to tilt laterally relative to the feeder 34 (e.g., in the tilt direction indicated by arrow 82 in FIG. 2). In one embodiment, the header 32 may be coupled to the feeder 34 roughly at a lateral centerline 83 defined between the opposed lateral ends 33A, 33B of the central section 33. In such an embodiment, a lateral tilt actuator(s) 74 of the header adjustment system 70 (FIG. 1) may be configured to laterally tilt the header 32 relative to the ground 19 (e.g., as indicated by arrow 82) about a tilt axis 84 aligned with the lateral centerline 83 of the header 32.

In one embodiment, the header adjustment system 70 may include a pair of tilt actuators 74. For instance, as shown in FIG. 2, a first tilt actuator 74A may be coupled between the central section 33 and the feeder 34 along one lateral side of the connection between the header 32 and the feeder 34, and a second tilt actuator 74B may be coupled between the central section 33 and the feeder 34 along the opposed lateral side of the connection between the header 32 and the feeder 34. In such an embodiment, the tilt actuators 74A, 7B may be extended and retracted to pivot or tilt the header 32 about the tilt axis 84 of the header 32. For instance, FIG. 3 illustrates an exemplary tilt range when titling the header 32 in the tilt direction 82 about the central tilt axis 84. As shown, the central section 33 of the header 32 may, for example, be tilted in one direction to a first maximum tilt angle (e.g., as shown by the solid lines) and in the opposed direction to a second maximum tilt angle (e.g., as shown by the dashed lines).

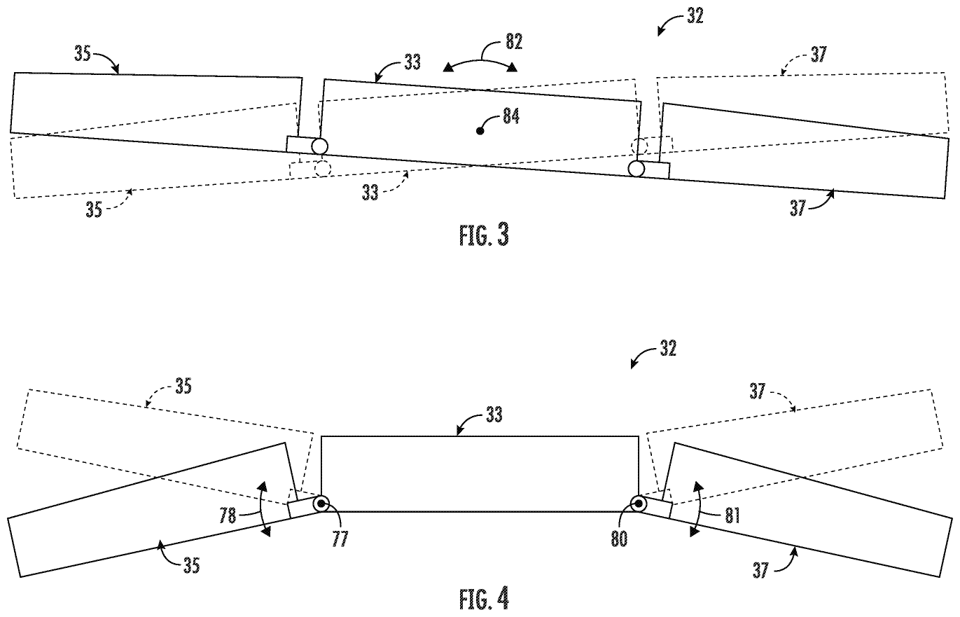

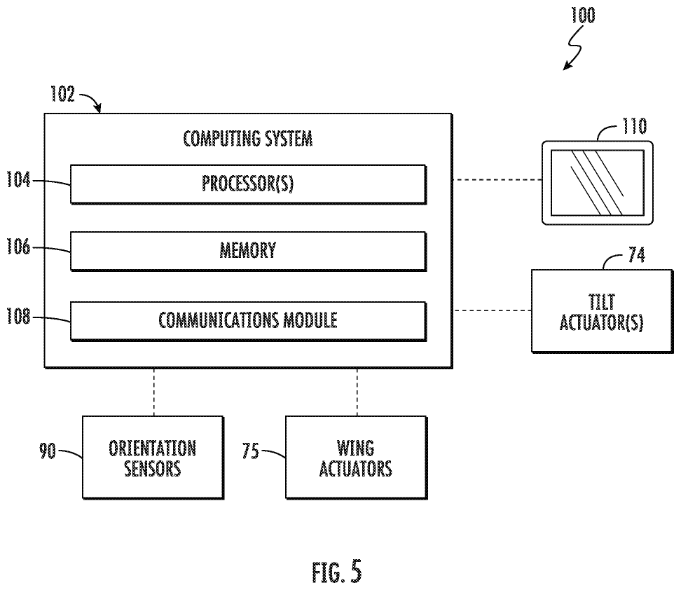

Referring back to FIG. 2, as indicated above, the header adjustment system 70 may also include wing actuators 75 configured to allow the orientation of wing sections 35, 37 of the header 32 to be adjusted relative to the central section 37 of the header 32. For instance, as shown in FIG. 2, a first wing actuator 75A is coupled between the central section 33 and the first wing section 35, while a second wing actuator 75B is coupled between the central section 33 and the second wing section 37. In such an embodiment, each actuator 75A, 75B may be extended or retracted to pivot its respective wing section 35, 37 about the associated pivot axis 77, 80. For instance, FIG. 4 illustrates exemplary pivot ranges when pivoting the wing sections 35, 37 relative to the central section 33 of the header. As shown, the first wing section 33 may be pivoted about the first pivot axis 77 relative to the central section 33 in one direction to a first minimum pivot angle (e.g., as shown by the solid lines) and in the opposed direction to a first maximum pivot angle (e.g., as shown by the dashed lines). Similarly, as shown in FIG. 4, the second wing section 35 may be pivoted about the second pivot axis 80 relative to the central section 33 in one direction to a second minimum pivot angle (e.g., as shown by the solid lines) and in the opposed direction to a second maximum pivot angle (e.g., as shown by the dashed lines).

Referring back to FIG. 2, the header adjustment system 70 may also include one or more orientation sensors 90 configured to monitor the orientation of the header 32 relative to the ground 19 and/or relative to another reference (e.g., a reference plane). For instance, as shown in FIG. 2, the header adjustment system 70 may include a first orientation sensor 90A configured to monitor the tilt angle of the central section 33 of the header 32. Additionally, as shown in FIG. 2, the header adjustment system 70 may include second and third orientation sensors 90B, 90C configured to monitor the pivot angles of the first and second wing sections 35, 37, respectively, relative to the central section 33. In the illustrated embodiment, the orientation sensors 90 are shown as being installed on the header 32. However, in other embodiments, one or more of such sensors 90 may be installed at any other suitable location that allows for the orientation of the header 32 to be monitored. For instance, the first orientation sensor 90 may be mounted or supported on the feeder 34 and/or the associated tilt actuator(s) 74.

It should be appreciated that the orientation sensors 90 may generally correspond to any suitable sensors or sensing devices configured to generate data that is directly or indirectly associated with the orientation of the various sections 33, 35, 37 of the header 32. For instance, suitable orientation sensors 90 may include inertial measurement units (IMUs), accelerometers, gyroscopes, rotary encoders, rotational position sensors, and/or the like.

Referring now to FIG. 5, a schematic view of one embodiment of a system 100 for visualizing the orientation of a harvesting implement (such as the header 32 described above) is illustrated in accordance with aspects of the present subject matter. In general, the system 100 will be described herein with reference to the header 32 described above with reference to FIG. 2. However, it should be appreciated that the disclosed system 100 may be used to assist with visualizing the orientation of any suitable harvesting implement having any suitable implement configuration.

In several embodiments, the system 100 may include a computing system 102 and various components, features, systems and/or sub-systems configured to be communicatively coupled to the computing system 102 (e.g., the tilt actuators 74, the wing actuators 75, orientation sensors 90, etc.). In general, the computing system 102 may be configured to perform various computer-related functions or tasks, including, for example, receiving data from one or more components, features, systems and/or sub-systems of the header 32 and/or associated agricultural harvester 10, storing and/or processing data received or generated by the computing system 102, and/or controlling the operation of one or more components, features, systems and/or sub-systems of the header 32 and/or associated agricultural harvester 10. As will be described below, the computing system 102 may be configured cause a graphical user interface (GUI) to be presented to the operator of the harvester 10 via an associated display device 110 that provides a visualization of the current orientation of the various sections 33, 35, 37, of the header 32.

In general, the computing system 102 may correspond to any suitable processor-based device(s), such as a computing device or any combination of computing devices. Thus, as shown in FIG. 5, the computing system 102 may generally include one or more processor(s) 104 and associated memory devices 106 configured to perform a variety of computer-implemented functions (e.g., performing the methods, steps, and the like disclosed herein). As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device 106 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device 106 may generally be configured to store information accessible to the processor(s) 104, including data that can be retrieved, manipulated, created and/or stored by the processor(s) 104 and instructions that can be executed by the processor(s) 104.

As further shown in FIG. 5, the computing system 102 is configured to be communicatively coupled to various other components of the system 100. For instance, the computing system 102 is communicatively coupled to the various actuators for controlling movement of the various sections 33, 35, 37 of the header 32, such as the tilt actuator(s) 74 and the wing actuators 75. As such, the computing system 102 may be configured to control the operation of the actuators 74, 75 to move or actuate the various sections of the 33, 35, 37 of the header 32. For instance, the operation of the tilt actuator(s) 74 may be controlled by the computing system 102 to adjust the tilt angle of the central section 33 of the header 32 relative to the ground (or relative to some other reference feature, such as the feeder 32), while the operation of each wing actuator 75 may be controlled by the computing system 102 to adjust the pivot angle of the respective wing section 35, 37 of the header 32 relative to the central section 33. As shown in FIG. 5, the computing system 102 is also configured to be communicatively coupled to the orientation sensors 90. As such, the computing system 102 may be configured to receive data from the orientation sensors 90 indicative of the current orientation of the various sections 33, 35, 37 of the header 32 (e.g., the current tilt angle of the central section 33 and/or the current pivot angles of the wing sections 35, 37).

Additionally, as shown in FIG. 5, the computing system 102 may also be configured to be communicatively coupled to a display device 110 configured to present a graphical user interface associated with the current orientation of the various sections 33, 35, 37 of the header 32. In one embodiment, the display device 110 may form part of a user interface of the associated agricultural harvester 10. For instance, in one embodiment, the display device 110 may be housed within the operator's cab 22 of the harvester 10. Alternatively, the display device 110 may form part, of a separate device or machine, such as a portable electronic device. For instance, in one embodiment, the display device 110 may be configured as the display (e.g., a touch screen) for a portable client device, such as a smartphone or a tablet.

In some embodiments, the computing system 102 may be configured to include one or more communications modules or interfaces 108 to allow the computing system 102 to communicate with any of the various system components described herein. For instance, one or more communicative links or interfaces (e.g., one or more data buses) may be provided between the communications interface 108 and each of the actuator(s) 74, 75 to allow the computing system 102 to control the operation of the actuator(s) 74, 75. Similarly, one or more communicative links or interfaces (e.g., one or more data buses) may be provided between the communications interface 108 and the orientation sensors 90 to allow for communications between the computing system 102 and the sensors 90. Additionally, one or more communicative links or interfaces (e.g., one or more data buses) may be provided between the communications interface 108 and the display device 110 to allow the computing system 102 to transmit data and/or suitable control signals to the display device 110 for display information to an operator or other user of the system.

As will be described below, in several embodiments, the computing system 102 may be configured to actively monitor the current orientation of the various sections 33, 35, 37 of the header 32 via the data received from the sensors 90 and transmit suitable data to allow for the presentation of an associated “implement orientation interface” to an operator via the display device 1110. Additionally, when a change in the orientation of one or more of the header sections 33, 35, 37 is detected (e.g., via the data received from the sensors 90), the computing system 110 may be configured to update the “implement orientation interface”, as necessary, to ensure that a visualization providing an accurate depiction of the current orientation of the header 32 is being presented to the operator or other system user.

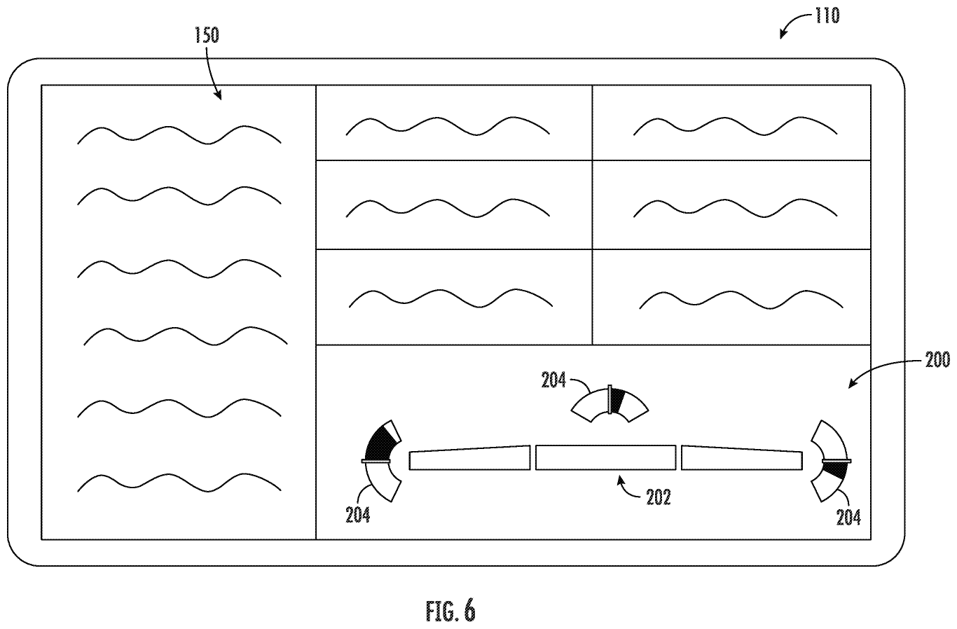

Referring now to FIG. 6, a schematic view of the display device 110 is illustrated in accordance with aspects of the present subject matter, particularly illustrating the display device 110 presenting a graphical user interface (GUI) 150 thereon. As shown, the GUI 150 may include numerous interface or display elements for presenting information to the operator/user, including information related to the operation of the header 32 and/or the associated harvester 10. In accordance with aspects of the present subject matter, the GUI 150 incorporates or includes an implement orientation interface 200 that is adapted to provide a visualization of the current orientation of a harvesting implement (e.g., the header 32 described above), including the orientation of any separate sections of the harvesting implement (e.g., the various sections 33, 35, 37 of the header 32 described above). As shown in FIG. 6, the implement orientation interface 200 may include an implement interface element 202 providing a graphical or visual presentation of the harvesting implement and one or more curved display indicators 204 positioned relative to the implement interface element 202. As will be described below, the curved display indicator(s) 204 may generally be configured to provide an indication of the current orientation of the harvesting implement. For instance, the curved display indicator(s) 204 may include suitable interface elements (e.g., pointers, indicator lines, arced indicators, and/or the like) that provide a visual indication of the current orientation of the harvesting implement. As such, by viewing the implement interface element 202 presented on the display device 110, an operator/user may quickly and easily determine the current orientation of the harvesting implement.

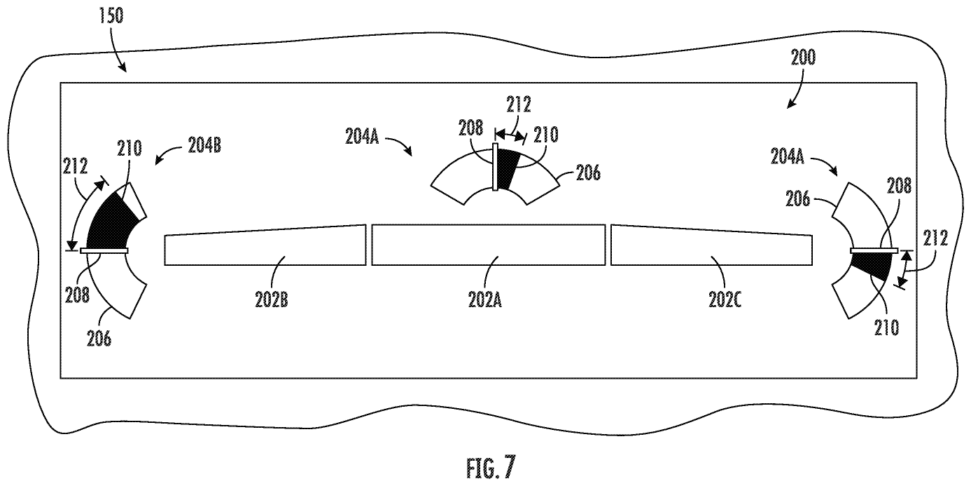

Referring now to FIG. 7, an enlarged view of a portion of the GUI 150 shown in FIG. 6 is illustrated in accordance with aspects of the present subject matter, particularly illustrating the implement orientation interface 200 of the GUI 150. As indicated above, the implement orientation interface 200 may generally include an implement interface element 202 and one or more curved display indicators 204 positioned relative to the implement interface element 202. As particularly shown in FIG. 7, the implement interface element 202 may generally be configured to provide a graphical or visual representation of the harvesting implement or header currently installed on the associated harvester. As such, the implement interface element 202 may correspond to any suitable image or schematic depiction representing the header currently installed on the associated harvester. For instance, in the illustrated embodiment, the implement interface element 202 provides a schematic depiction of an articulating header, such as the header 32 described above. In such an embodiment, the implement interface element 202 may include a central interface portion 202A representing the central section 33 of the header 32, a first wing interface portion 202B positioned along one side of the central interface portion 202A so as to represent the first wing section 35 of the header 32, and a second wing interface portion 202C positioned along the opposed side of the central interface portion 202A so as to represent the second wing section 37 of the header 32. As such, when viewing the implement orientation interface 200, the implement interface element 202 provides a quick and easily comprehensible visual representation of the header currently installed on the harvester 10.

Additionally, as indicated above, the curved display indicator(s) 204 may generally be configured to provide an indication of the current orientation of the harvesting implement. As shown in FIG. 7, the implement orientation interface 200 includes three curved display indicators 204 for indicating the current orientation of each depicted section of the header. Specifically, the implement orientation interface 200 includes a central curved display indicator 204A positioned adjacent to the central interface portion 202A (e.g., above the central interface portion 202A) for indicating the orientation (i.e., the tilt angle) of the central section 33 of the header 32. Additionally, the implement orientation interface 200 includes a first wing-related curved display indicator 204B positioned adjacent to the first wing interface portion 202B (e.g., to the side of the first wing interface portion 202B opposite the central interface portion 202A) for indicating the orientation (i.e., the pivot angle) of the first wing section 35 of the header 32, and a second wing-related curved display indicator 204C positioned adjacent to the second wing interface portion 202C (e.g., to the side of the second wing interface portion 202C opposite the central interface portion 202A) for indicating the orientation (i.e., the pivot angle) of the second wing section 37 of the header 32. However, in other embodiments, the implement orientation interface 200 may include any other number of curved display indicators 204, such as by only including the central curved display indicator 204A to provide an indication of the tilt angle of the header 32 or by only including the first and second wing-related curved display indicators 204B, 204C to provide an indication of the pivot angles of the wing sections 35, 37 relative to the central section 33 of the header 32.

In several embodiments, each curved display indicator 204 includes a curved indicator bar 206 and one or more indicator elements 208, 210 positioned relative to the curved indicator bar 206 to provide an indication of the angular orientation of the associated section of the header. As shown in the illustrated embodiment, each curved indicator bar 206 corresponds to a curved or arced display element having a given arc length and defining a given radius of curvature. In such an embodiment, the associated indicator element(s) 208, 210 of each curved display indicator 204 may be configured to indicate the degree of articulation (i.e., the angular orientation) of the respective header section based on the relative positioning of the element(s) 208, 210 along the curved indicator bar 206. Specifically, as shown in FIG. 7, the indicator element(s) includes a reference indicator line 208 and an arced indicator 210 extending from the indicator line 208, with an arc length 212 of the arced indicator 210 providing a visualization of the associated angular orientation of the header section. For instance, the reference indicator line 208 may be set at a reference orientation for the header section (e.g., a horizontal orientation). As the header section is tilted or pivoted away from such reference orientation, the arc length 212 of the arced indicator 210 will increase and extend outwardly from the reference indicator line 298 to indicate the current orientation of the header section relative to the reference orientation.

For example, in the illustrated embodiment, the central curved display indicator 204A indicates that the central section 33 of the header 32 is currently tilted to the right relative to the reference orientation by a given degree corresponding to the arc length 212 of the associated arced indicator 210. Additionally, the first wing-related curved display indicator 204B indicates that the first wing section 35 of the header 32 is currently pivoted upward relative to the reference orientation by a given degree corresponding to the arc length 212 of the associated arced indicator 210. Similarly, the second wing-related curved display indicator 204C indicates that the second wing section 37 of the header 32 is currently pivoted downward relative to the reference orientation by a given degree corresponding to the arc length 212 of the associated arced indicator 210.

It should be appreciated that the curved display indicators may correspond to dynamic display elements of the implement orientation interface 200 and, thus, may be updated, as necessary, to reflect the current orientation of each section of the header. Specifically, as indicated above, the computing system 102 may be configured to continuously monitor the current orientation of the various sections of the header via the data received from the orientation sensors 90. Thus, as changes in the orientation of one or more of the header sections is detected, the computing system 102 may be configured to cause the associated curve display indicator(s) to be updated to reflect the new or changing orientation of the header section(s). For instance, as one of the header sections is being actuated to adjust the orientation of such section relative to the reference orientation, the arc length 212 of the associated arced indicator 210 may be increased or decreased, depending on the actuation direction, to provide a visualization of such actuation of the header section.

It should also be appreciated that, in the illustrated embodiment, the implement interface element 202 is configured as a static display element of the GUI 150 and, thus, the various portions 202A, 202B, 202C of such interface element 202 remain unchanged as the orientation of the various header sections is changed. However, in other embodiments, the implement interface element 202 may be configured as a dynamic display element of the GUI 150. For instance, in one embodiment, the orientation of the various interface portions 202A, 202B, 202C within the GUI 150 may be varied in accordance with changes in the orientation of the associated sections of the header 32.

By configuring the implement orientation interface 200 as described above, the disclosed system 100 may provide a very intuitive means for allowing operators/users to visualize the current orientation of the associated header. Specifically, since the tilting/pivoting motion of the header is typically measured by angular rotation, the use of a curved display indicator allows the operator/user to more intuitively understand the header motion that is being identified by the interface 200. Additionally, by using the indicator elements in combination with a curved indicator bar, the operator/user can intuitively understand the degree of movement of the associated header section.

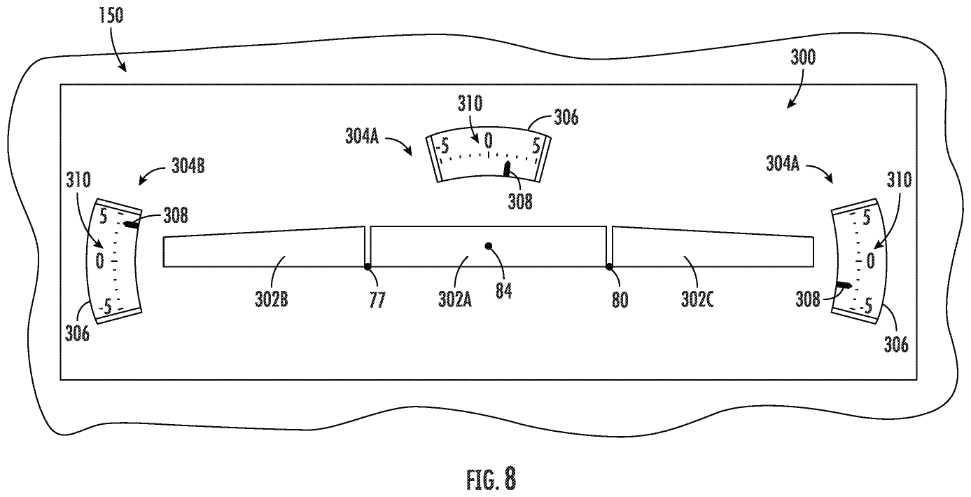

Referring now to FIG. 8, another embodiment of an implement orientation interface 300 that can be used as all or part of a graphical user interface is illustrated in accordance with aspects of the present subject matter. Similar to the embodiment described above, the implement orientation interface 300 generally includes an implement interface element 302 and one or more curved display indicators 304 positioned relative to the implement interface element 302. As particularly shown in FIG. 8, the implement interface element 302 is generally configured the same as the implement interface element 202 described above. For instance, in the illustrated embodiment, the implement interface element 302 includes a central interface portion 302A representing the central section 33 of the header 32, a first wing interface portion 302B positioned along one side of the central interface portion 202A so as to represent the first wing section 35 of the header 32, and a second wing interface portion 302C positioned along the opposed side of the central interface portion 202A so as to represent the second wing section 37 of the header 32.

Additionally, similar to the embodiment described above, the implement orientation interface 300 includes three curved display indicators 304 for indicating the current orientation of each depicted section of the header. Specifically, the implement orientation interface 300 includes a central curved display indicator 304A positioned adjacent to the central interface portion 302A (e.g., above the central interface portion 302A) for indicating the orientation (i.e., the tilt angle) of the central section 33 of the header 32. Additionally, the implement orientation interface 300 includes a first wing-related curved display indicator 304B positioned adjacent to the first wing interface portion 302B (e.g., to the side of the first wing interface portion 302B opposite the central interface portion 302A) for indicating the orientation (i.e., the pivot angle) of the first wing section 35 of the header 32, and a second wing-related curved display indicator 304C positioned adjacent to the second wing interface portion 302C (e.g., to the side of the second wing interface portion 302C opposite the central interface portion 302A) for indicating the orientation (i.e., the pivot angle) of the second wing section 37 of the header 32.

As shown in FIG. 8, each curved display indicator 304 includes a curved indicator bar 306 and one or more indicator elements 308, 310 positioned relative to the curved indicator bar 306 to provide an indication of the angular orientation of the associated section of the header. Similar to the embodiment described above with reference to FIG. 7, each curved indicator bar 306 corresponds to a curved or arced display element having a given arc length and defining a given radius of curvature. In the illustrated embodiment, the radius of curvature of each curved indicator bar 306 is centered at or adjacent to the location of the tilt/pivot axis of the associated header sections (as represented via the interface portions 302A, 302B, 302C). For instance, as shown in FIG. 8, the radius of curvature of the curved indicator bar 306 for the central curved display indicator 304A is generally centered at or adjacent to the center of the central interface portion 302A, which is generally representative of the location of the tilt axis 84 of the central section 33 of the header 32 (e.g., as indicated by point 84 in FIG. 8). Additionally, the radius of curvature of the curved indicator bar 306 for the first wing-related curved display indicator 304B is generally centered at or adjacent to the bottom portion of the interface defined between the first wing interface portion 302B and the central interface portion 302A, which is generally representative of the location of the pivot axis 77 of the first wing section 35 of the header 32 (e.g., as indicated by point 77 in FIG. 8). Similarly, the radius of curvature of the curved indicator bar 306 for the second wing-related curved display indicator 304C is generally centered at or adjacent to the bottom portion of the interface defined between the second wing interface portion 30CB and the central interface portion 302A, which is generally representative of the location of the pivot axis 80 of the second wing section 35 of the header 32 (e.g., as indicated by point 90 in FIG. 8).

Additionally, similar to the embodiment described above, the associated indicator element(s) 308, 310 of each curved display indicator 304 may be configured to indicate the degree of articulation (i.e., the angular orientation) of the respective header section based on the relative positioning of the element(s) 308 along the curved indicator bar 306. Specifically, as shown in FIG. 8, the indicator element(s) includes a pointer line 308 and a scale 310 extending across the curved indicator bar 306. In such an embodiment, the pointer line 308 may be used to indicate the current angular orientation of the associated header section along the scale 310. For instance, in the illustrated embodiment, the scale 310 generally provides for a range of angular values extending from a maximum angle (e.g., five) to a minimum angle (e.g., negative give), with the angular range being centered at zero (i.e., a tilt/pivot angle of zero). Accordingly, the based on the position of the pointer line 308 along the scale 310, an operator/user can quickly and easily determine the current orientation of each header section.

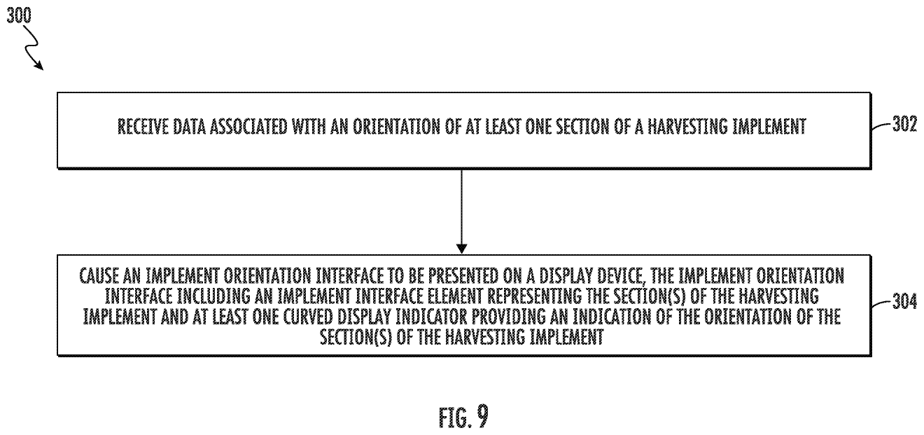

Referring now to FIG. 9, a flow diagram of one embodiment of a method 300 for visualizing the orientation of a harvesting implement relative to a ground surface is illustrated in accordance with aspects of the present subject matter. For purposes of discussion, the method 200 will generally be described herein with reference to the header 32 shown in FIGS. 1 and 2 and the system 100 shown in FIG. However, it should be appreciated that the disclosed method 200 may be used to assist with visualizing the current orientation of any suitable harvesting implement having any other suitable implement configuration and/or in association with any suitable system having any other suitable system configuration. Additionally, although FIG. 9 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 6, at (302) the method 300 may include receiving data associated with an orientation of at least one section of a harvesting implement. Specifically, as indicated above, the computing system 102 may be communicatively coupled to one or more orientation sensors 90 configured to generate data associated with the orientation of a respective section of a header. In such an embodiment, each sensor 90 may be configured to transmit orientation data to the computing system for subsequent analysis and/or processing.

Additionally, at (304), the method 300 may include causing an implement orientation interface to be presented on display device, the implement orientation interface including an implement interface element representing the at least one section of the harvesting implement and at least one curved display indicator providing an indication of the orientation of the at least one section of the harvesting implement. Specifically, as indicated above, the computing system 102 may be configured to control the operation of an associated display device 110 or otherwise transmit suitable data to the display device 110 to allow for the presentation of an implement interface element that provides an indication of the current orientation of one or more sections of a harvesting implement.

It is to be understood that the steps of the method 200 are performed by the computing system 102 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the computing system 102 described herein, such as the method 200, is implemented in software code or instructions which are tangibly stored on a tangible computer readable medium. The computing system 102 loads the software code or instructions via a direct interface with the computer readable medium or via a wired and/or wireless network. Upon loading and executing such software code or instructions by the computing system 102, the computing system 102 may perform any of the functionality of the computing system 102 described herein, including any steps of the method 200 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for visualizing the orientation of a harvesting implement configured for use with an agricultural harvester, the system comprising:
a display device; and
a computing system communicatively coupled to the display device, the computing system being configured to:
receive data associated with an orientation of at least one section of the harvesting implement; and
cause an implement orientation interface to be presented on the display device, the implement orientation interface including an implement interface element representing the at least one section of the harvesting implement and at least one curved display indicator positioned relative to the implement interface element, the at least one curved display indicator providing an indication of the orientation of the at least one section of the harvesting implement.

2. The system of claim 1, wherein the controller is further configured to cause the presentation of the at least one curved display indicator to be updated when the data indicates that the orientation of the at least one section of the harvesting implement has changed.

3. The system of claim 1, further comprising at least one orientation sensor configured to generate the data associated with the orientation of the at least one section of the harvesting implement, the computing system being configured to receive the data from the at least one orientation sensor.

4. The system of claim 1, wherein the at least one curved display indicator includes a curved indicator bar and at least one indicator element configured to indicate the orientation of the at least one section of the harvesting implement based on a relative positioning of the at least one indicator element along the curved indicator bar.

5. The system of claim 4, wherein the at least one indicator element is an arced indicator element defining an arc length within the curved indicator bar, the arc length of the arced indicator indicating the orientation of the at least one section of the harvesting implement.

6. The system of claim 4, wherein the at least one indicator element comprises a pointer element movable along a scale defined relative to the curved indicator bar to indicate the orientation of the at least one section of the harvesting implement.

7. The system of claim 4, wherein a radius of curvature of the curved indicator bar is centered at or adjacent to a hinge or tilt axis of the at least one section of the harvesting implement.

8. The system of claim 1, wherein the at least one section of the harvesting implement comprises a central section of the harvesting implement, a first wing section of the harvesting implement, and a second wing section of the harvesting implement, the implement interface element including a central interface portion representing the central section of the harvesting implement, a first wing interface portion positioned on one side of the central interface portion and representing the first wing section, and a second wing interface portion positioned on an opposed side of the central interface portion and representing the second wing section.

9. The system of claim 8, wherein the at least one curved display indicator comprises a first wing-related curved display indicator providing an indication of the orientation of the first wing section and a second wing-related curved display indicator provided an indication of the orientation of the second wing section.

10. The system of claim 9, wherein the at least one curved display indicator further comprises a central curved display indicator providing an indication of the orientation of the central section.

11. A method for visualizing the orientation of a harvesting implement configured for use with an agricultural harvester, the method comprising:
receiving, with a computing system, data associated with an orientation of at least one section of the harvesting implement; and
causing, with the computing system, an implement orientation interface to be presented on the display device, the implement orientation interface including an implement interface element representing the at least one section of the harvesting implement and at least one curved display indicator positioned relative to the implement interface element, the at least one curved display indicator providing an indication of the orientation of the at least one section of the harvesting implement.

12. The method of claim 11, further comprising updating the at least one curved display indicator when the data indicates that the orientation of the at least one section of the harvesting implement has changed.

13. The method of claim 11, wherein receiving the data comprise receiving the data from at least one orientation sensor.

14. The method of claim 11, wherein the at least one curved display indicator includes a curved indicator bar and at least one indicator element, the method further comprising adjusting a relative positioning of the at least one indicator element along the curved indicator bar within the implement orientation interface to indicate changes in the orientation of the at least one section of the harvesting implement.

15. The method of claim 14, wherein the at least one indicator element an arced indicator element defining an arc length within the curved indicator bar, wherein adjusting the relative positioning of the at least one indicator element along the curved indicator bar comprises increasing or decreasing the arc length of the arced indicator to indicate changes in the orientation of the at least one section of the harvesting implement.

16. The method of claim 14, wherein the at least one indicator element comprises a pointer element movable along a scale defined relative to the curved indicator bar, wherein adjusting the relative positioning of the at least one indicator element along the curved indicator bar comprises moving the pointer element along the scale to indicate changes in the orientation of the at least one section of the harvesting implement.

17. The method of claim 14, wherein a radius of curvature of the curved indicator bar is centered at or adjacent to a hinge or tilt axis of the at least one section of the harvesting implement.

18. The method of claim 11, wherein the at least one section of the harvesting implement comprises a central section of the harvesting implement, a first wing section of the harvesting implement, and a second wing section of the harvesting implement, the implement interface element including a central interface portion representing the central section of the harvesting implement, a first wing interface portion positioned on one side of the central interface portion and representing the first wing section, and a second wing interface portion positioned on an opposed side of the central interface portion and representing the second wing section.

19. The method of claim 18, wherein the at least one curved display indicator comprises a first wing-related curved display indicator providing an indication of the orientation of the first wing section and a second wing-related curved display indicator provided an indication of the orientation of the second wing section.

20. The method of claim 19, wherein the at least one curved display indicator further comprises a central curved display indicator providing an indication of the orientation of the central section.
